(19) United States
(12) Patent Application Publication
(10) Pub. No.: US 2009/0290252 A1
(43) Pub. Date: Nov. 26, 2009

(54) INFORMATION MEMORY DEVICE

(75) Inventor: Satoru Fukase, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/353,802

(22) Filed: Jan. 14, 2009

(30) Foreign Application Priority Data
May 21, 2008 (JP) 2008-133396

(51) Int. Cl. G11B 5/596

(52) U.S. Cl. 360/77.07; G9B/5.216

(57) ABSTRACT

A control circuit which controls recording of data in a disk recording medium in an information memory device provided with the disk recording medium that rotates and has tracks of plural data sectors; a head that relatively moves along the tracks; and a recording section that records data in plural data sectors by using the head, the control circuit including: a detection section which detects whether the head is positioned at a track where a recording target exists; and a control section which makes the recording section record the data if the head is positioned at the track; or interrupts the recording if the head runs off from the track; and resumes the recording from a data sector subsequent to the data sector where the head is again positioned at the track and begins recording in the interrupted data sector when the head is rotated to the interrupted data sector.

### CROSS-REFERENCE TO RELATED APPLICATION

This application is based upon and claims the benefit of priority of the prior Japanese Patent Application No. 2008-133396, filed on May 21, 2008, the entire contents of which are incorporated herein by reference.

### FIELD

The embodiments discussed herein are related to an information memory device, a control circuit thereof, and a recording method.

### BACKGROUND

An information memory device typified by a Hard Disk Drive (HDD) is frequently used by being incorporated in a computer or externally provided. A HDD includes a disk recording medium composed of tracks in which plural data sectors are arranged. While the disk recording medium is rotated, a magnetic head is positioned at a target track, and pieces of data are sequentially recorded in a data sector. When the HDD receives vibrations from the outside, sometimes the magnetic head runs off from the track and the data is not written in the target data sector. For example, if a HDD is mounted on a portable computer in which a display or a speaker is integrally attached, when a sound is reproduced through the speaker, the vibration reaches the HDD, and sometimes the magnetic head periodically runs off from the track.

A determination whether or not the magnetic head is positioned at the target track is made by reading a servo pattern disposed in the track. In order to prevent the data from being written off the target track due to vibrations, a confirmation whether or not the magnetic head is positioned at the track is made each time the servo pattern is read, and recording is interrupted when run-off of the magnetic head is detected (for example, see Japanese Patent No. 3317340). Recording of the interrupted data in the data sector is retried when the magnetic head moves to the data sector in the next rotation of the disk recording medium.

FIG. 1 is an explanatory view illustrating recording in data sectors of a magnetic disk medium in a conventional HDD. FIG. 1 illustrates timing at which servo sectors and data sectors pass through a magnetic head when the magnetic head relatively moves along the tracks of the magnetic disk with the rotation of the magnetic disk. FIG. 1 illustrates eight servo sectors of a servo sector 0 to a servo sector 7. Three data sectors are disposed between a certain servo sector and the next servo sector, and 21 data sectors of a data sector 0 to a data sector 20 are disposed between the servo sector 0 and the servo sector 7. FIG. 1 illustrates an example in which pieces of data are written in the 21 data sectors when vibrations are added to the HDD at time intervals of three servo sectors.

In the example of FIG. 1, the recording of the data sector 0 subsequent to the servo sector 0 is interrupted when run-off from the track is detected by reading the servo pattern from the servo sector 0 (mark of “x” in FIG. 1). The recording is retried when the data sector 0 where recording is interrupted moves to the position of the magnetic head in the second round of the magnetic disk. Then, when the run-off from the track is detected by reading the servo pattern from the servo sector 2, the recording in the data sector 6 subsequent to the servo sector 2 is interrupted, and the recording is resumed when the data sector 6 reaches the position of the magnetic head in the third round of the magnetic disk. In the example of FIG. 1, five rounds of the magnetic disk are required to perform the recording for the 21 data sectors. Assuming that one round of the magnetic disk takes 11 ms, then recording for the 21 data sectors takes 55 ms. In this way, when vibrations frequently occur, the time for recording data is lengthened by waiting for rounds of the magnetic disk. During retries, the computer possibly becomes a standby state to cause a functional disturbance.

In view of the foregoing, there is provided an information memory device in which a delay of the time necessary to store data is suppressed when vibrations are added, a control circuit thereof, and a recording method.

### SUMMARY

According to a basic mode of the invention, there is provided a control circuit which controls recording of data in a disk recording medium in an information memory device which includes:

the disk recording medium which rotates and has tracks in which plural data sectors are circularly arranged and data is recorded in each of the plurality of data sectors;

a head which relatively moves along the tracks of the disk recording medium and records the data in the disk recording medium and reads the data from the disk recording medium; and

a recording section which receives data corresponding to plural data sectors and records the data in the corresponding plural data sectors by using the head, the control circuit including:

a detection section which detects whether or not the head is positioned at a track to which data sectors of a recording target belongs; and

a control section which causes the recording section to record the data in the data sectors if the detection section detects that the head is positioned at the track; causes the recording section to interrupt the recording if the detection section detects that the head runs off from the track; and causes the recording section to resume the recording from a data sector subsequent to the data sector where the detection section detects again that the head is positioned at the track and also causes the recording section to begin recording in the data sector where the recording is interrupted when the head is rotated to the interrupted data sector.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating recording in data sectors of a magnetic disk medium in a conventional HDD;

FIG. 2 is a block diagram illustrating a HDD as a specific embodiment of an information memory device;

FIG. 3 is a flowchart illustrating normal write processing performed in the HDD of FIG. 2;

FIG. 4 is a flowchart illustrating write end waiting processing performed in the HDD of FIG. 2;

FIG. 5 is a flowchart illustrating servo interrupt processing performed in the HDD of FIG. 2;

FIG. 6 is a flowchart illustrating write stop interrupt processing performed in the HDD of FIG. 2;

FIG. 7 is a flowchart illustrating off-track state obtaining processing performed in the HDD of FIG. 2;

FIG. 8 is a flowchart illustrating write error processing performed in the HDD of FIG. 2;

FIG. 9 is a flowchart illustrating normal retry processing performed in the HDD of FIG. 2;

FIG. 10 is a timing chart illustrating an example of timing of recording in data sectors of the magnetic disk in the HDD of FIG. 2;

FIG. 11 is a timing chart illustrating an example of timing of read and interrupt processing in servo sectors and data sectors; and

FIG. 12 is a timing chart illustrating an example of a change in shift amount of the magnetic head from a track.

### DESCRIPTION OF EMBODIMENTS

It is preferable to employ an application mode for the control circuit in the information memory device of the above-described basic mode, in which a plurality of servo sectors are disposed at intervals in the track, and a servo pattern indicating a position of the head with respect to the track is recorded in the servo sectors;

the detection section detects a shift amount of the head from the track by reading the servo pattern from each of the plurality of servo sectors; and

the control section instructs the recording section to resume the recording according to a locus of the shift amount of the head if the detection section detects that the head is positioned at the track, after detecting that the head runs off from the track.

For example, if a large shock is given, sometimes the head cannot immediately return to the track. In this preferable application mode, recording can be resumed by selecting a case in which the recording time is effectively suppressed by resuming the recording based on the locus of the shift amount.

It is preferable to employ an application mode for the above-described application mode of the control circuit, in which the control section causes the recording section to resume the recording from a data sector subsequent to a next servo sector of the servo sector where the detection section detects that the head is positioned at the track, if the detection section detects that the head is positioned at the track after detecting that the head runs off from the track.

In this preferable application mode, the recording can securely be started from a data sector subsequent to the servo sector while the servo pattern is completely read to detect that the head is positioned at the track.

It is preferable to employ an application mode that further includes a determination section which determines, if the detection section detects that the head runs off from the track, whether or not data is recorded in a data sector antecedent to the servo sector where the detection section detects that the head runs off from the track, according to a locus of the shift amount of the head.

In this preferable application mode, it is possible to make a determination whether or not the data is recorded in the data sectors antecedent to the servo sector in which the run-off of the head is detected to increase recording certainty.

It is preferable to employ an application mode for the control circuit in which the information memory device is a hard disk device.

The recording method of the information memory device and the information memory device disclosed in the invention include not only the basic mode but also various application modes corresponding to application modes of the control circuit of the information memory device.

Specific embodiments of the information memory device, the control circuit thereof, and the recording method for the basic mode and application mode will be described below with reference to the drawings.

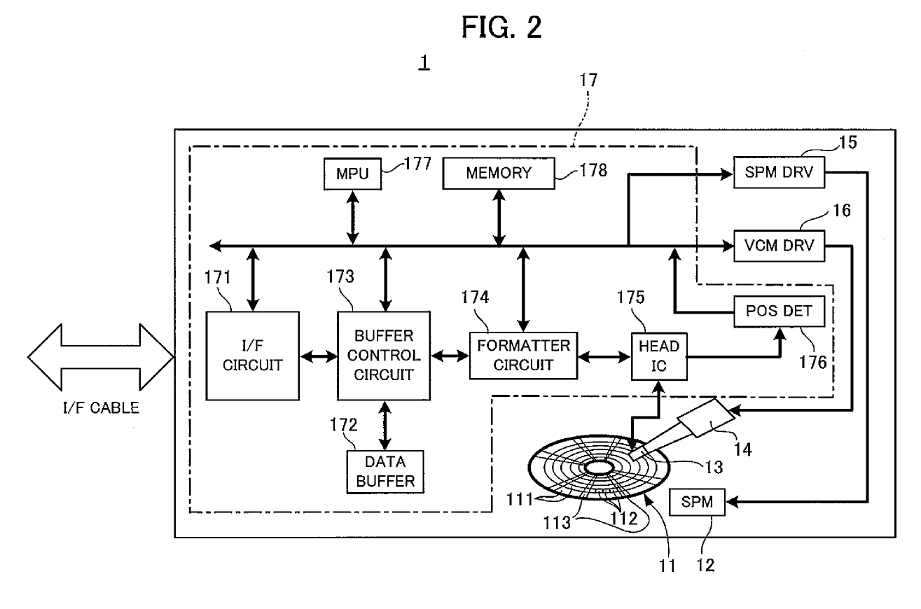

FIG. 2 is a block diagram illustrating a HDD as a specific embodiment of an information memory device.

A HDD 1 of FIG. 2 is incorporated in a computer such as a personal computer (not illustrated, hereinafter referred to as a host computer) or externally provided, and the HDD 1 is used as an auxiliary memory device of the host computer. The HDD 1 includes a magnetic disk 11 as a disk recording medium, a spindle motor (SPM) 12 which rotates the magnetic disk 11, a magnetic head 13 which records data in the magnetic disk 11 and reads data from the magnetic disk 11, a voice coil motor (VCM) 14 as a head drive section to move the magnetic head 13, a SPM driver (SPM_DRV) 15 which drives the SPM 12, a VCM driver (VCM_DRV) 16 which drives the VCM 14, and a control circuit 17 which controls the SPM driver 15 and VCM driver 16 while transmitting and receiving a signal indicating the data to and from the magnetic head 13.

Plural tracks 111 are concentrically arranged in the magnetic disk 11, and plural data sectors 112 are circularly disposed in each track. Plural servo sectors 113 are disposed at intervals in the tracks 111, and servo patterns indicating a position of the magnetic head with respect to the tracks 111 is recorded in the servo sectors 113. Data is recorded in the data sectors 112. In the magnetic disk 11, the data is recorded or read in each data sector 112. In the magnetic disk 11, the magnetization is arranged along the tracks 111 and a value of information bit is expressed by an orientation of the magnetization. The servo pattern includes a pattern for distinguishing the tracks and servo sectors and a pattern for reading a shift amount of the magnetic head from the track.

In the recording and reading (reproducing) the data in and from the magnetic disk 11, the control circuit 17 causes the VCM driver 16 to drive the VCM 14 based on positional information read from the servo sector 113, thereby moving the magnetic head 13 onto the target track of the magnetic disk 11. The movement of the magnetic head 13 between the tracks is called seek. The positioned magnetic head 13 relatively moves along the tracks 111 of the magnetic disk 11 with the rotation of the magnetic disk 11. In recording the data, an electric recording signal is fed into the magnetic head 13 from the control circuit 17. The magnetic head 13 applies a magnetic field to record the information according to the fed recording signal. In reading the data, the magnetic head 13 takes out the information recorded in the form of magnetization direction by generating an electric reproduction signal according to the magnetic field generated from the magnetization, and the magnetic head 13 supplies the information to the control circuit 17. The magnetic head 13 also reads a servo pattern of the servo sector 113.

The control circuit 17 controls the recording of the data in the magnetic disk 11 of the HDD 1 and the readout of the data from the magnetic disk 11. The control circuit 17 includes an interface (I/F) circuit 171, a data buffer 172 in which data is tentatively stored, a buffer control circuit 173 which controls the data buffer 172, a formatter circuit 174 which converts the data according to the recording format on the magnetic disk, a head IC 175 which amplifies and relays the signal from the magnetic head 13, a position detecting circuit (POS_DET) 176 which detects the position of the magnetic head 13, a Micro Processing Unit (MPU) 177 which controls each section of the HDD 1, and a memory 178 in which a program executed by the MPU 177 is stored.

The interface circuit 171 receives a command and the data written in the magnetic disk 11 from the host computer (not illustrated) externally connected to the HDD 1. The interface circuit 171 supplies the data read from the magnetic disk 11 to the host computer.

The buffer control circuit 173 stores the data received in the interface circuit 171 and the data read from the magnetic disk 11 in the data buffer 172. For example, the data buffer 172 is formed by a DRAM. Part of the data buffer 172 is used as a storage section in which operation data of the MPU 177 or various flags are stored.

In recording the data, the formatter circuit 174 receives the data supplied from the interface circuit 171 through the data buffer 172, converts the supplied data, and records the data in the data sector corresponding to the data by using the magnetic head 13. More particularly, when the MPU 177 sets the data recording, the formatter circuit 174 supplies the signal corresponding to the data to the magnetic head 13 at a timing corresponding to the data sector designated by the MPU 177 based on a number of the track and a number of the servo sector which are read from the servo pattern by the magnetic head 13. In reading the data, the formatter circuit 174 takes in the data signal at timing of the sector designated by the MPU 177 based on the servo pattern read by the magnetic head 13. The data sector which becomes the recording or reading target is designated by the MPU 177. The formatter circuit 174 receives the pieces of data corresponding to the plural data sectors, and the formatter circuit 174 can sequentially record the pieces of data in the plural data sectors of the magnetic disk 11. When the recording or reading is completed for the designated sector, the formatter circuit 174 supplies an interrupt signal to notify the MPU 177 of the end of the processing. During the recording, the formatter circuit 174 supplies the interrupt signal each time the magnetic head 13 reads the servo pattern from the servo sector. In the case where the recording is interrupted by the setting of the MPU 177, the formatter circuit 174 also supplies the interrupt signal. The formatter circuit 174 corresponds to an example of the recording section in the basic mode.

The position detecting circuit 176 detects the shift amount of magnetic head from the center of the track as the position of the magnetic head according to the signal which is read from the servo pattern by the magnetic head 13. The shift amount is read by the MPU 177.

The MPU 177 executes the program to control each section of the HDD 1. For example, the memory 178 is formed by a nonvolatile memory such as a flash memory. Various programs which are executed by the MPU 177 to realize various pieces of processing of the HDD 1 and constants necessary for the various programs are stored in the memory 178. The MPU 177 executes the program stored in the memory 178 with the data buffer 172 as a working area.

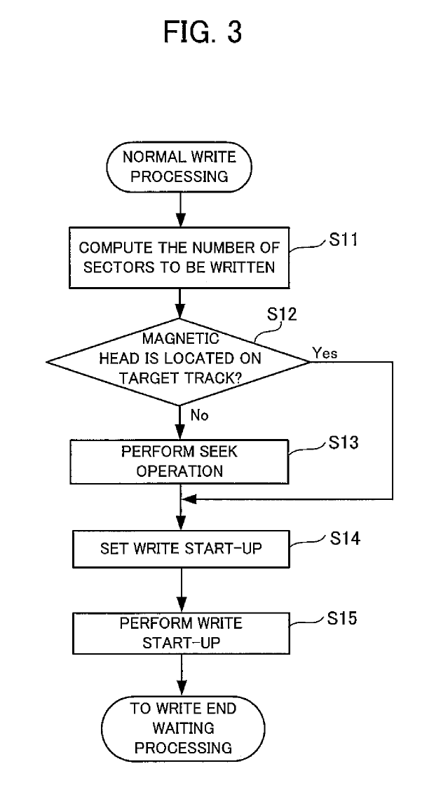

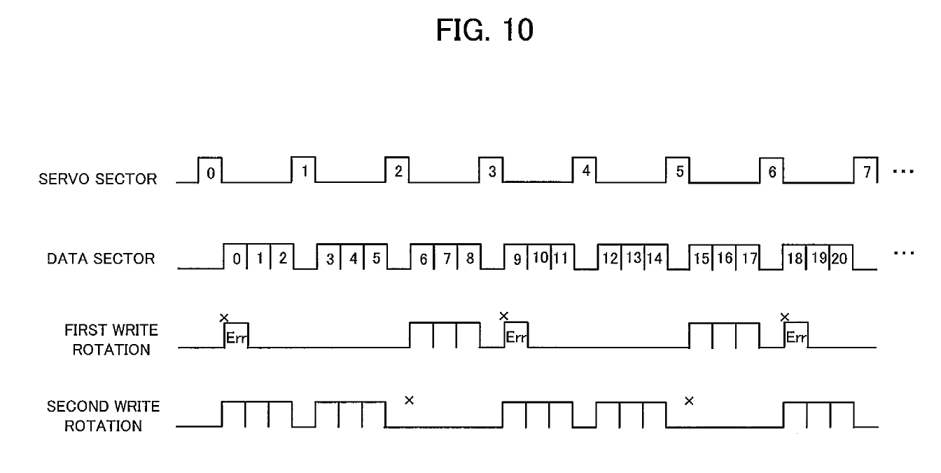

FIGS. 3 to 9 are flowcharts illustrating data recording processing performed in the HDD of FIG. 2. FIGS. 3 to 9 mainly illustrate the processing performed by the MPU 177. FIG. 10 is a timing chart illustrating an example of timing of recording in data sectors of the magnetic disk in the HDD of FIG. 2. FIG. 10 illustrates the timing of the servo sectors and data sectors the magnetic head 13 passes through when the magnetic head 13 relatively moves along the target track with the rotation of the magnetic disk 11. FIG. 10 illustrates eight servo sectors of a servo sector 0 to a servo sector 7, and three data sectors are disposed between a certain servo sector and the next servo sector. That is, 21 data sectors of a data sector 0 to a data sector 20 are disposed between the servo sector 0 and the servo sector 7. FIG. 10 illustrates an example in which pieces of data are written in the 21 data sectors.

The processing performed in the HDD 1 of FIG. 2 will be described with reference to the flowcharts of FIGS. 3 to 9 and the example of the timing chart of FIG. 10.

FIG. 3 is a flowchart illustrating normal write processing.

The normal write processing is performed when the HDD 1 receives a recording command from the host computer. In the HDD 1, the interface circuit 171 receives the command from the host computer, and the interface circuit 171 transmits the command to the MPU 177. The data is also supplied from the host computer with the command, and the buffer control circuit 173 stores the data in the data buffer 172. The host computer supplies the data corresponding to one or plural data sectors, and the recording command includes information indicating directly or indirectly the data sector in which the data is recorded. When receiving the recording command and the data, the MPU 177 computes the number of data sectors to be written in response to the command (step S11). For example, the number of data sectors is 21 when the recording command designates the data sector 0 to the data sector 20.

The MPU 177 computes the number of target track the data sector belongs to. When the magnetic head 13 is not positioned at the target track (No in step S12), the MPU 177 performs the seek operation (step S13). More particularly, the MPU 177 causes the VCM driver 16 to drive the VCM 14 to position the magnetic head 13 onto the target track.

Then the MPU 177 sets write start-up (step S14). More particularly, the MPU 177 sets the number of the data sector of the recording target at the formatter circuit 174. For example, the MPU 177 sets the data sector 0 to the data sector 20 as the data sector of the recording target, and the MPU 177 also sets the positions of the data buffer 172 in which the pieces of data corresponding to the data sectors are stored. Then the MPU 177 performs the write start-up (step S15). More particularly, the MPU 177 sets the recording start in the formatter circuit 174. Therefore, the formatter circuit 174 reads the data from the data buffer 172 to perform various conversions, and the formatter circuit 174 supplies the data signal to the magnetic head 13 at the timing corresponding to the set data sector based on the information which is read from the servo pattern by the magnetic head 13. For example, the formatter circuit 174 reads the data from the data buffer 172 in the order from the data sector 0, performs the data conversion, and supplies the signal to the magnetic head 13. After the normal write processing, write end waiting processing is performed.

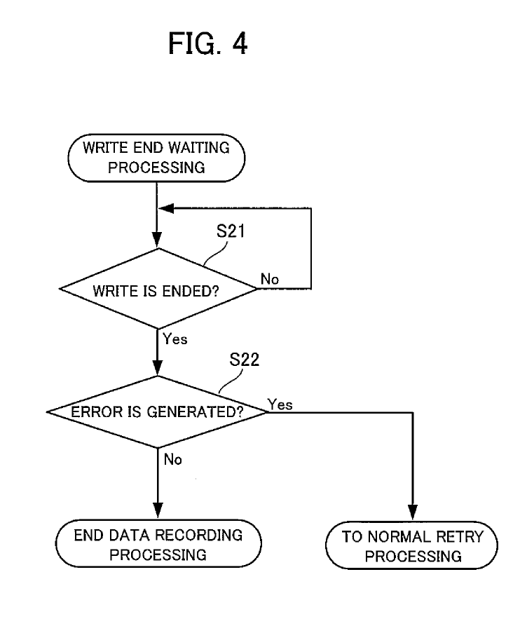

FIG. 4 is a flowchart illustrating the write end waiting processing.

In the write end waiting processing, the MPU 177 repeatedly determines whether or not the write is ended (step S21). More particularly, the MPU 177 determines whether or not a write end flag stored in a storage area of the data buffer 172 is set through the later-mentioned interrupt processing. The MPU 177 performs the later-mentioned various pieces of interrupt processing according to input of an interrupt signal during loop processing in step S21.

When the MPU 177 determines that the write is ended (Yes in step S21), the MPU 177 confirms an error (step S22). More particularly, the MPU 177 determines whether or not a write error flag stored in the data buffer 172 is set through the later-mentioned interrupt processing. When the MPU 177 determines that the error does not exist (No in step S22) all the pieces of data are written in response to the recording command, and the MPU 177 ends the data recording processing. When the MPU 177 determines that the error exists (Yes in step S22), the MPU 177 performs retry processing. The retry processing is described later.

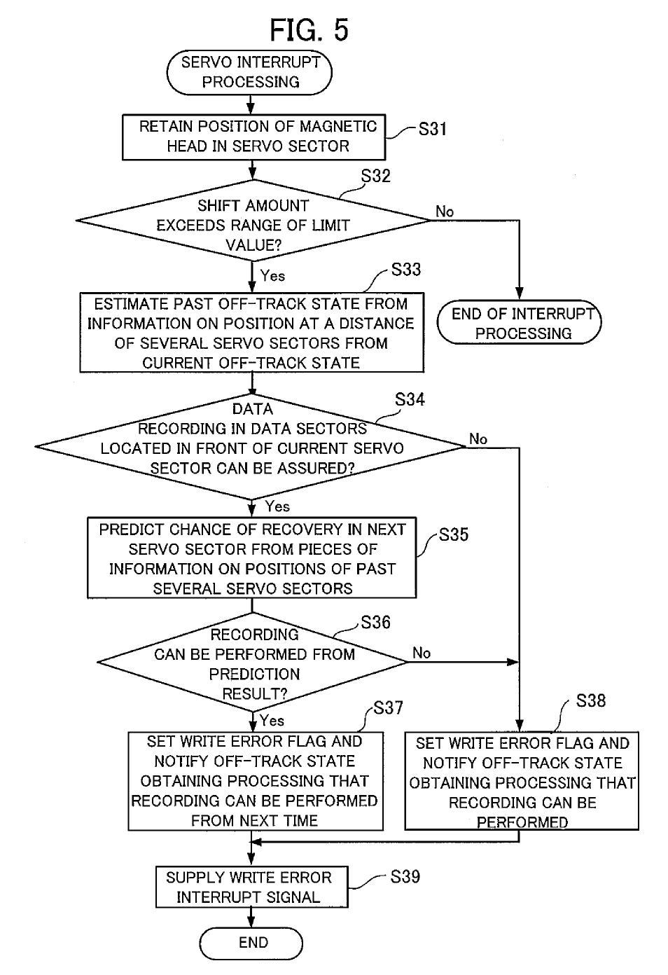

FIG. 5 is a flowchart illustrating servo interrupt processing.

The servo interrupt processing is performed each time the magnetic head 13 passes through the servo sector to read the servo pattern, while the recording is set in the formatter circuit 174 (see step S15). More particularly, the servo interrupt processing is performed immediately after the magnetic head 13 completes the readout of the servo pattern.

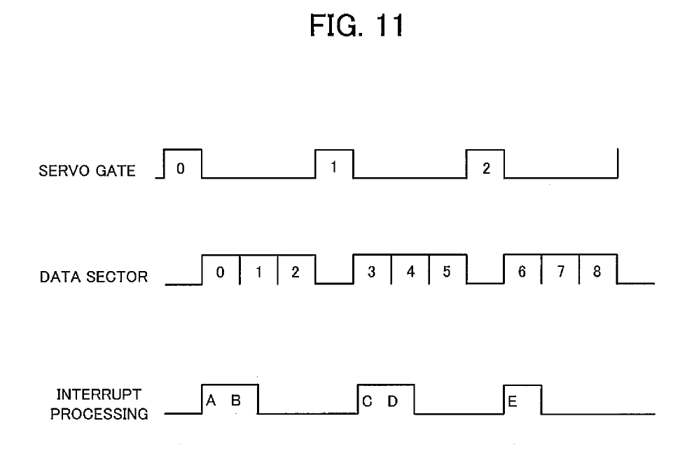

FIG. 11 is a timing chart illustrating an example of timing of read and interrupt processing in the servo sector and the data sector. FIG. 11 illustrates times corresponding to the data sector 0 to the data sector 8 in an enlarged manner. A servo gate indicates timing at which the magnetic head 13 reads the servo pattern from the servo sector.

The servo interrupt processing is performed at the timing designated by the letter A of FIG. 11 after the servo sector 0 is read. The timing of the servo interrupt processing overlaps the recording timing of the data sector 0 subsequent to the servo sector 0.

In the servo interrupt processing of FIG. 5, the MPU 177 retains the position of the magnetic head in the servo sector which becomes a factor of the current interrupt processing (step S31). More particularly, the MPU 177 reads and retains the shift amount of the magnetic head which is detected by reading the servo pattern from the servo sector with the position detecting circuit 176. For example, in the case where the processing is performed at the timing A of FIG. 11, the position of the magnetic head in the servo sector 0 read at the last minute is retained. The history of the position is retained for past several times of the servo interrupt processing.

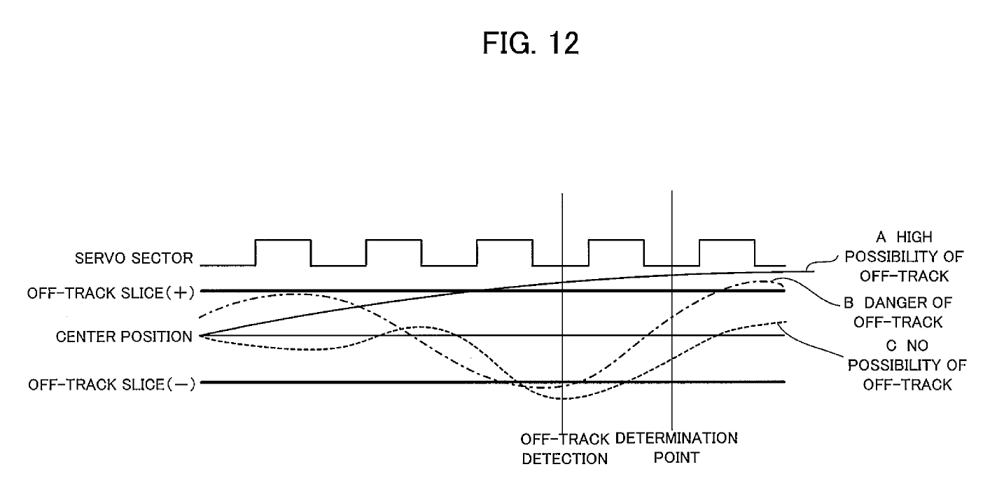

FIG. 12 is a timing chart illustrating an example of a change in shift amount of the magnetic head from the track. FIG. 12 illustrates loci A, B, and C which are an example of modifications of the shift amount. The shift amount of the magnetic head from the track is changed incessantly according to the vibration added to the HDD 1 or the tracking control. In the case where the shift amount is within an off-track slice indicated by a bold line of FIG. 12, the magnetic head is positioned at the track, and the data is normally written in the data sector. A state in which the shift amount is out of the off-track slice is called off-track in which the magnetic head runs off from the target track. Actually a limit value of the off-track slice is set with a margin wider than the range where the recording can be performed in the data sector. The shift amount is discretely detected at the timing synchronized with the servo sector of FIG. 12.

After the retaining processing in step S31 of FIG. 5, the MPU 177 detects whether or not the magnetic head is in the off-track state (step S32). More particularly, the MPU 177 determines whether or not the shift amount retained in step S31 exceeds the range of positive-side limit value and a negative-side limit value of the off-track slice of FIG. 12. For example, in each case of the example of FIG. 12, the shift amount exceeds the off-track slice range, that is, the shift amount exceeds the range between the positive-side limit value and the negative-side limit value at the timing of “off-track detection”, and the MPU 177 determines that the magnetic head is in the off-track state.

When the MPU 177 determines that the magnetic head is not in the off-track state, that is, when the magnetic head is positioned at the target track (No in step S32),the interrupt processing is immediately ended. At this point, the formatter circuit 174 transmits the data signal corresponding to the data sector to the magnetic head 13 to perform the recording into the data sector until the interrupt processing by the next servo sector.

On the other hand, when the MPU 177 determines that the magnetic head is in the off-track state (Yes in step S32) the MPU 177 estimates the past off-track state from the information on the position at a distance of several servo sectors from the current off-track state (step S33). At this point, according to the locus of the shift amount, the MPU 177 determines whether or not the data is recorded in the data sector followed by the servo sector in which the off-track is detected. More particularly, plural assumed patterns are previously prepared from a computed value and an experimental value of a control theory for the change in shift amount. That is, the off-track state prior to the current servo sector is estimated by determining to which pattern a combination of the history of the shift amounts over the several servo sectors and the current shift amount matches.

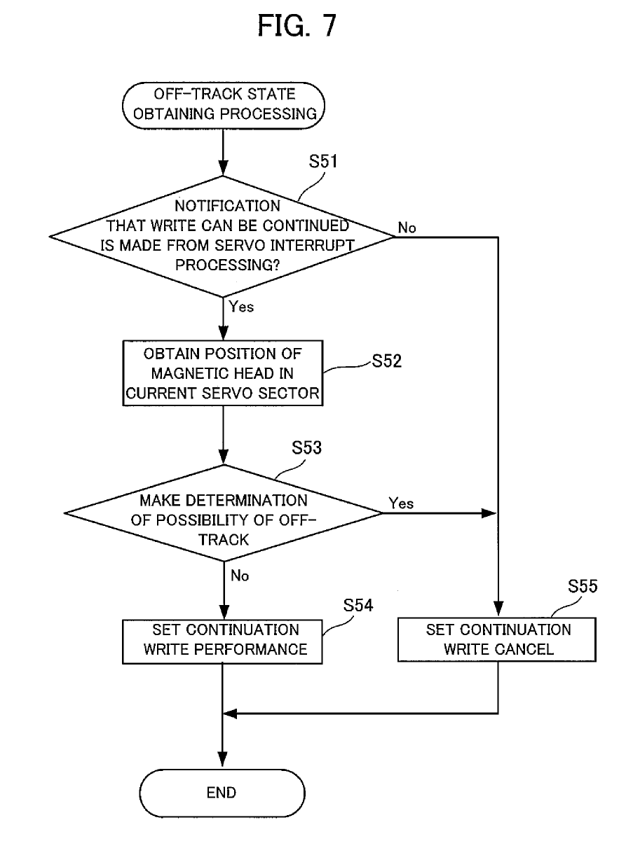

For example, in the case where the magnetic head is in the off-track state in step S32, when the shift amounts of several times up to the previous time are close to the limit value of FIG. 12, and when the current shift amount largely exceeds the limit value, it is estimated that the magnetic head 13 runs off from the track even in the data sectors antecedent to the currently-read servo sector and possibly the data is not recorded in the data sector. On the contrary, when the current shift amount slightly exceeds the limit value, and when the shift amounts of several times up to the previous time are located near the center position, in the data sectors antecedent to the currently-read servo sector, it is estimated that the shift amount of the magnetic head from the track falls within the range where the data can normally be recorded and the data is recorded. In step S33, the MPU 177 estimates the off-track state of the data sector antecedent to the servo sector whose shift amount is currently detected by matching the history of the past shift amount with the assumed pattern. Based on the estimation in step S33, the MPU 177 determines whether or not the data is recorded in the data sector antecedent to the servo sector in which the off-track is detected (step S34). As a result of the estimation processing in step S33, when the MPU 177 determines that the recording of the data in the data sectors antecedent to the current servo sector can be assured (Yes in step S34), the MPU 177 predicts a chance of recovery from the off-track state in the next servo sector (step S35). For example, when the past shift amounts alternatively oscillate between the positive side and the negative side of the center value, it is estimated that the shift amount of the head diverges and the normal recording cannot be continued without performing the seek processing. The MPU 177 predicts the chance of recovery from the off-track state of the servo sector whose shift amount is currently detected in the next servo sector by matching the history of the past shift amount with the assumed pattern. As a result of prediction, when the shift amount falls within the recordable range in the next servo sector to be able to record the data in the next servo sector (Yes in step S36), the MPU 177 sets a flag indicating the continuation write can be performed while setting the write error flag, and the MPU 177 notifies another pieces of processing (off-track state obtaining processing of FIG. 7) that it is predicted that the recording can be resumed from the next time (Step S37). On the other hand, when the MPU 177 determines that the recording of the data in the data sectors antecedent to the current servo sector cannot be assured (No in step S34), or when the MPU 177 determines that the recording is hardly continued (No in Step S36), the MPU 177 sets the write error flag, and the MPU 177 notifies another pieces of processing that the recording cannot be continued by clearing the flag indicating that the continuation write can be performed (step S38). The recording certainty is improved by making the determination of the recording into the past servo sector according to the locus.

After the processing in step S37 or step S38, the MPU 177 sets forced recording end in the formatter circuit 174 to cause the formatter circuit 174 to interrupt the recording, and the formatter circuit 174 supplies a write error interrupt signal (step S39). When the off-track is detected in step S32, the recording in the data sector is interrupted. When the formatter circuit 174 supplies the write error interrupt signal through the processing in step S39, write stop interrupt processing is performed.

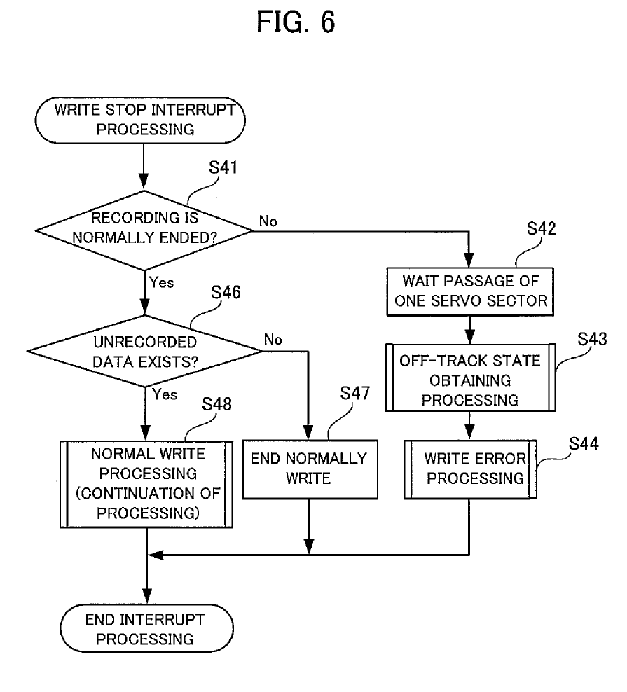

FIG. 6 is a flowchart illustrating the write stop interrupt processing.

The write stop interrupt processing is performed when the recording is normally ended while the pieces of data are written in all the data sectors set by the formatter circuit 174, or when the data recording is ended at the mid point by setting the forced recording end in the formatter circuit 174 in the servo interrupt processing.

In the write stop interrupt processing, the MPU 177 determines whether or not the recording is normally ended (step S41). More particularly, the MPU 177 reads the setting of the formatter circuit 174 to determine whether or not the forced recording end is set in the servo interrupt processing. When the recording is normally ended, that is, when the forced recording end is not set (Yes in step S41), the MPU 177 determines whether or not the unrecorded data in which the recording is not performed exists in the data sector in which the recording is set in the normal write processing of FIG. 3 (step S46). How the unrecorded data is generated is described later. When the unrecorded data does not exist (No in step S46), the write error flag is set at the write normal end (step S47), and the interrupt processing is ended. For example, the vibration is not given from the outside, the pieces of data are continuously written from the data sector 0 to the data sector 20, and the shift amount obtained from the servo sector 0 to the servo sector 7 falls within the off-track slice range. In such cases, all the pieces of data are recorded only by one round of the magnetic disk 11, and the write stop interrupt processing is ended through the pieces of processing in steps S41, S46, and S47. On the other hand, when the recording is not normally ended, that is, when the forced recording end is set in the formatter circuit 174 (No in step S41), waiting for the passage of the one servo sector is performed (step S42). More particularly, the MPU 177 waits for the readout of the next servo sector from the magnetic head 13 while stopping the data recording. Then the MPU 177 performs off-track state obtaining processing (see FIG. 7) (step S43). In the example of the timing chart of FIG. 11, the write stop interrupt processing of FIG. 6 is performed at the timing designated by the letter B, and the off-track state obtaining processing in step S43 is performed at the timing designated by the letter C.

FIG. 7 is a flowchart illustrating the off-track state obtaining processing.

In the off-track state obtaining processing, the MPU 177 determines whether or not the notification that the write can be continued is made from the servo interrupt processing of FIG. 5 (Step S51). More particularly, the MPU 177 determines whether a flag indicating that the write can be continued is set or cleared. When the MPU 177 determines that the write can be continued, the position of the magnetic head in the current servo sector after waiting for the passage of the one servo sector (see Step S42 of FIG. 6), that is the shift amount is obtained (step S52), and the MPU 177 determines whether or not a possibility of generating the off-track exists after that (step S53). Through steps S52 and S53, the MPU 177 issues an instruction to the formatter circuit 174 to resume the recording according to the locus of the shift amount of the magnetic head. More particularly, the MPU 177 makes a determination of the possibility of generating the off-track after that from the shift amount currently obtained in step S53 and the previous shift amount, that is, the shift amount when the off-track is detected. FIG. 12 illustrates the loci A, B, and C of the shift amounts. For example, in the locus A, in the case where the currently obtained shift amount exceeds the limit value again, there is a high possibility of generating the off-track after that. In the locus B, in the case where the sign of the shift amount becomes opposite to the previously detected shift amount even if the currently obtained shift amount falls within the off-track slice range, possibly the fluctuation in shift does not converge, and there is a possibility of generating the off-track after that. In the locus C, the sign of the shift amount is matched with that of the previously detected shift amount while the currently obtained shift amount falls within the off-track slice range, so that the MPU 177 determines that the possibility of generating the off-track does not exist. The MPU 177 determines that the possibility of generating the off-track exists in other cases. For example, for the loci A and B, the MPU 177 determines that the possibility of generating the off-track exists. For the locus C, the MPU 177 determines that the possibility of generating the off-track does not exist.

When the MPU 177 determines that the possibility of generating the off-track does not exist (No in step S53), the MPU 177 sets continuation write performance (step S54), and the off-track state obtaining processing is ended. More particularly, the MPU 177 sets a continuation write performance flag indicating the continuation write performance. On the other hand, when the MPU 177 determines that the possibility of generating the off-track exists (Yes in Step S53), or the MPU 177 determines that the notification that the write can be continued is made in step S51, the MPU 177 sets continuation write cancel (step S55), and the off-track state obtaining processing is ended. More particularly, the MPU 177 clears the continuation write performance flag indicating the continuation write performance.

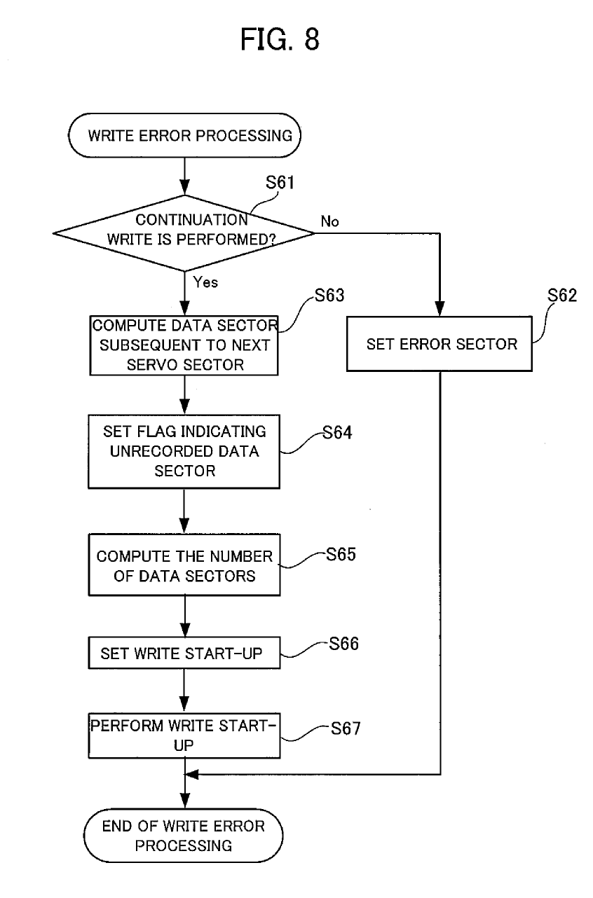

Referring to FIG. 6, write error processing (see FIG. 8) is performed (step S44) after the off-track state obtaining processing (step S43). In the timing chart of FIG. 11, the write error processing (step S44) is performed at timing designated by the letter D.

FIG. 8 is a flowchart illustrating the write error processing.

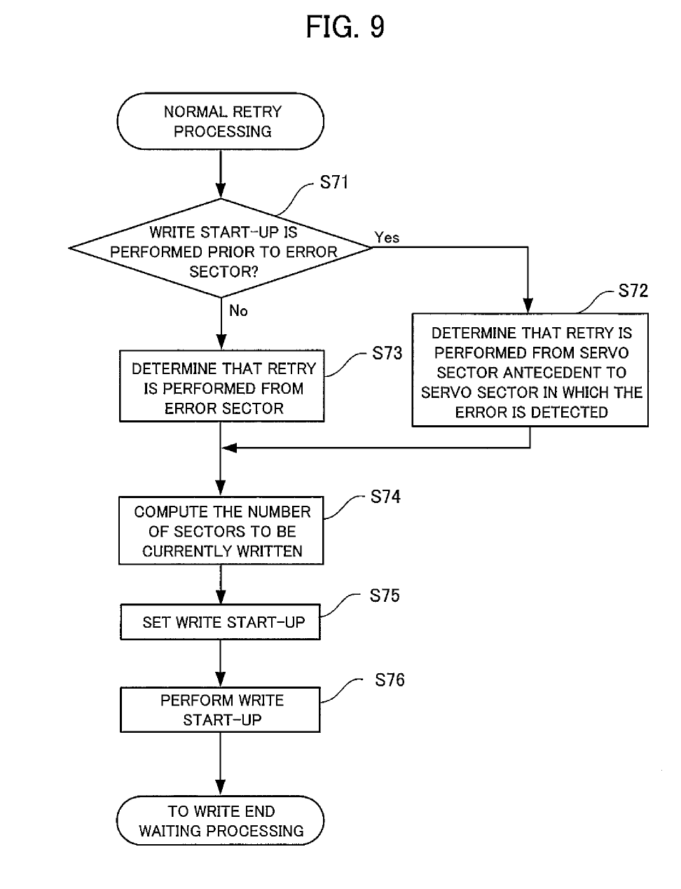

In the write error processing, the MPU 177 determines whether or not the continuation write is performed (Step S61). More particularly, the MPU 177 determines whether or not the continuation write performance flag is set. When the continuation write cancel is set (No in step S61), the MPU 177 determines that the recording is hardly continued without performing the seek processing again, the MPU 177 sets the write error flag while setting the number of the error sector, that is, the data sector in which the error is detected to interrupt the recording (step S62), and the write error processing is ended. The write error flag is referred to in the write end waiting processing of FIG. 4, thereby performing the normal retry processing (see FIG. 9).

Referring to FIG. 8, when the continuation write performance is set in step S61 (Yes in step S61), the number of the data sector subsequent to the next servo sector is computed (Step S63). Then the information indicating unrecorded is set in the memory for the pieces of data scheduled to be written in the data sectors from the data sector in which the error is detected to interrupt the recording to the data sector followed by the next servo sector. This is because the mark is added to the pieces of data in order to perform the recording again in the next time although the recording is currently interrupted. Specifically, a flag indicating unrecorded is set, and the flag is provided in each data sector in which the data recording is set.

The MPU 177 sets the number of the data sector subsequent to the next servo sector at the resuming head sector, and the MPU 177 computes the number of data sectors in which the recording is resumed (Step S65). The recording from the resuming head sector to the last sector is set (Step S66) and write start-up is performed (Step S67). Therefore, the formatter circuit 174 sequentially reads the pieces of data from the data corresponding to the resuming head sector, performs the conversion of the data, and supplies the signal to the magnetic head 13. As a result, the recording is resumed from the data sector after the MPU 177 detects again that the magnetic head 13 is positioned at the track. In the example of the timing chart of FIG. 11, the data recording is resumed from the data sector 6. At this point, the recording is resumed from the data sector (in the example of FIG. 10, data sector 6) subsequent to the servo sector (in the example of FIG. 10, servo sector 2) next to the servo sector (in the example of FIG. 10, servo sector 1) in which the MPU 177 detects that the magnetic head 13 is positioned at the track, so that the recording can securely be started from the data sector immediately subsequent to the servo sector while the servo pattern is completely read to detect that the magnetic head is positioned at the track.

Referring to FIG. 6, in the case where the data recording is resumed through the write error processing of FIG. 8, the write interrupt processing is performed when the data recording set in the formatter circuit 174 is completed. In this case, an affirmative determination is made in the processing in step S41 of FIG. 6, and it is determined in step S46 whether or not the unrecorded data remains. More particularly, it is determined in step S65 of FIG. 8 whether or not the information indicating the unrecorded data is set in any piece of data. When the unrecorded data remains, the normal write processing is performed to the unrecorded data (Step S48). In the normal write processing (FIG. 3), for example, the recording is set in the formatter circuit 174 for the data sectors of the data sector 0 to the data sector 5. The recording is interrupted in the data sector 0 to the data sector 5, and the flag indicating unrecorded is set at the data sector 0 to the data sector 5 by the processing in step S64. Therefore, the unrecorded data is recorded in the data sector at the time the magnetic head 13 reaches the data sector, in which the recording is interrupted, in the next rotation of the magnetic disk 11.

The processing for detecting whether or not the off-track is generated in step S32 in the servo interrupt processing of FIG. 5 corresponds to an example of the detection step in the application mode. The combination of the MPU 177 which performs the pieces of processing and the position detecting circuit 176 corresponds to an example of the detection section in the application mode. The normal write processing of FIG. 3, the pieces of processing in steps S35 to S39 in the servo interrupt processing of FIG. 5, the write stop interrupt processing of FIG. 6, the off-track state obtaining processing of FIG. 7, and the write error processing of FIG. 8 correspond to an example of the recording step in the basic mode and application mode. The MPU 177 which performs the pieces of processing corresponds to an example of the control section in the basic mode and application mode. The processing for estimating the past off-track state in step S33 of FIG. 5 and the determination processing in step S34 correspond to an example of the determination step in the application mode. The MPU 177 which performs the pieces of processing corresponds to an example of the determination section in the application mode.

An example of the recording will be described with reference to FIG. 10. FIG. 10 illustrates the example of the case in which the vibration is given at a period of three sectors.

When the vibration is added at the time magnetic head 13 passes through the servo sector 0 in the first rotation of the magnetic disk 11, the shift amount obtained by reading the servo pattern of the servo sector 0 becomes out of the off-track slice range (FIG. 12), the determination of the off-track is made in the servo interrupt processing (FIG. 5) and the recording processing is interrupted (step S39 of FIG. 5). The shift amount is obtained by waiting for the passage of the one servo sector (step S42 of FIG. 6) in the write error processing (FIG. 6) after the servo sector 1 is passed. Because the vibration is not added after the servo sector 0 is passed, the continuation write performance is set in the off-track state obtaining processing (FIG. 7). In the write interrupt processing (FIG. 8), the data sector 6 is defined as the data sector subsequent to the servo sector 2 in the processing in step S63. In the write start-up setting processing (step S67 of FIG. 8), the data recording is set in the formatter circuit 174 for the 15 data sectors of the data sector 6 to the data sector 20. Through the processing in step S64, the flag indicating unrecorded is set at the data sector 0 to the data sector 5 in which the recording is currently interrupted.

As a result of the write start-up setting processing, the formatter circuit 174 resumes the data recording to the data sectors from the data sector 6 subsequent to the servo sector 2. When the vibration is added at the time the magnetic head 13 passes through the servo sector 3, the data is unrecorded to the data sectors 9 to 14 subsequent to the servo sector 3, and the data recording is resumed from the data sector 15 subsequent to the servo sector 5. When the vibration is added at the time the magnetic head 13 passes through the servo sector 6, the data is unrecorded to the data sectors 18 to 20 subsequent to the servo sector 6. Thus, in the first rotation of the magnetic disk 11, the data recording in the data sector is interrupted by the vibration, the pieces of data are written in the data sectors 6 to 8 and the data sectors 15 to 17 although the data sectors 0 to 5, the data sectors 9 to 14, and the data sectors 18 to 20 are unrecorded.

In the first rotation, the recording is set in the normal write processing (step S48 of FIG. 6) in the write end waiting processing of FIG. 6 for the unrecorded data sectors 0 to 5, data sectors 9 to 14, and data sectors 18 to 20. In the second rotation, the pieces of data are written in the data sectors 0 to 5, data sectors 9 to 14, and data sectors 18 to 20. Although the vibration is added during the passage of the servo sector 2 and the passage of the servo sector 5 in the second rotation, the recording is not interrupted because the recording is completed in the first rotation for the data sector subsequent to the servo sector 2 and the data sector subsequent to the servo sector 5.

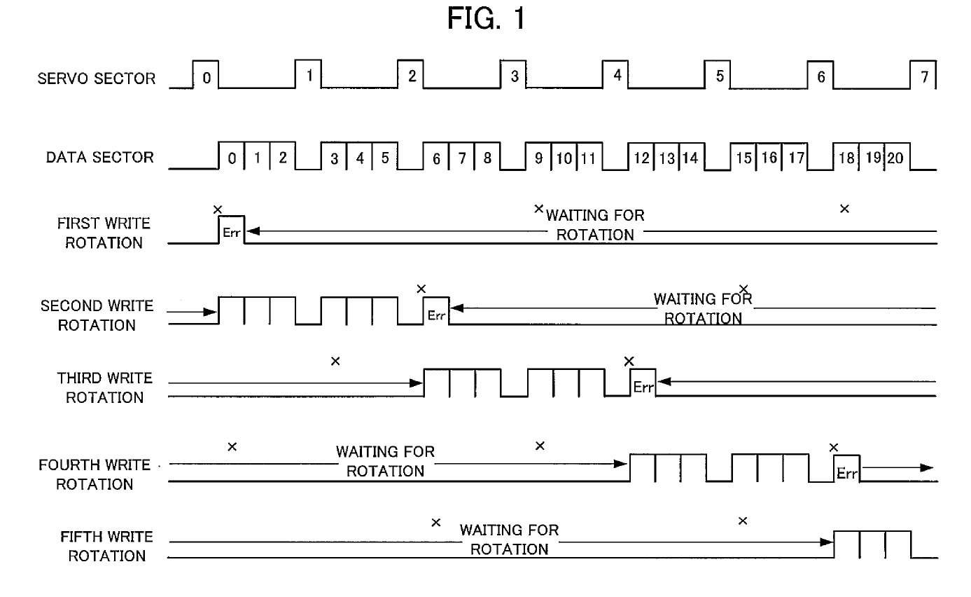

Accordingly, in the example of FIG. 10, the data recording is ended for the 21 data sectors while the magnetic disk is rotated twice. Assuming that one rotation of the magnetic disk takes 11 milliseconds, the recording for the 21 data sectors takes 22 milliseconds. Thus, when the vibration is added, the delay of the time necessary to store the data can be suppressed compared with the recording performed by the conventional HDD of FIG. 1.

The retry processing in the case where the determination of the existence of the error is made (Yes in Step S22 of FIG. 4) will be described below.

FIG. 9 is a flowchart illustrating normal retry processing.

In the normal retry processing, when the write start-up is performed before the sector in which the recording is interrupted by the error (Yes instep S71),the retry (recording retry) is performed from the servo sector antecedent to the servo sector in which the error is detected (step S72). On the other hand, when the write start-up is not performed before the sector in which the recording is interrupted by the error (No in step S71), the retry (recording retry) is performed from the data sector subsequent to the servo sector in which the error is detected (step S73).

The computation of the number of sectors in which the recording is performed (Step S74), the write start-up setting (Step S75), and the performance of the write start-up (Step S76) are similar to those in steps S11, S14, and S15 of FIG. 3. Therefore, the recording is tried again.

According to the basic mode described in the summary, the recording in the data sector whose recording is interrupted by vibrations waits for the next round of the magnetic disk. However, while waiting for the round, the recording is performed to the data sector after detecting again that the head is positioned at the track, so that the delay of the time to store the data can be suppressed.

Thus, in the basic mode of the information memory device, the control circuit thereof, and the recording method, the delay of the time necessary to store the data when vibrations are added is suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A control circuit which controls recording of data in a disk recording medium in an information memory device which comprises:
the disk recording medium which rotates and has tracks in which plural data sectors are circularly arranged and data is recorded in each of the plural data sectors;
a head which relatively moves along the tracks of the disk recording medium and records the data in the disk recording medium and reads the data from the disk recording medium; and
a recording section which receives data corresponding to plural data sectors and records the data in the corresponding plural data sectors by using the head,
the control circuit comprising:
a detection section which detects whether or not the head is positioned at a track to which data sectors of a recording target belongs; and
a control section which causes the recording section to record the data in the data sectors if the detection section detects that the head is positioned at the track; causes the recording section to interrupt the recording if the detection section detects that the head runs off from the track; and causes the recording section to resume the recording from a data sector subsequent to the data sector where the detection section detects again that the head is positioned at the track and also causes the recording section to begin recording in the data sector where the recording is interrupted when the head is rotated to the interrupted data sector.

2. The control circuit according to claim 1, wherein a plurality of servo sectors are disposed at intervals in the track, and a servo pattern indicating a position of the head with respect to the track is recorded in the servo sectors;
the detection section detects a shift amount of the head from the track by reading the servo pattern from each of the plurality of servo sectors; and
the control section instructs the recording section to resume the recording according to a locus of the shift amount of the head if the detection section detects that the head is positioned at the track, after detecting that the head runs off from the track.

3. The control circuit according to claim 2, wherein the control section causes the recording section to resume the recording from a data sector subsequent to a next servo sector of the servo sector where the detection section detects that the head is positioned at the track, if the detection section detects that the head is positioned at the track after detecting that the head runs off from the track.

4. The control circuit according to claim 2, further comprising a determination section which determines, if the detection section detects that the head runs off from the track, whether or not data is recorded in a data sector antecedent to the servo sector where the detection section detects that the head runs off from the track, according to a locus of the shift amount of the head.

5. The control circuit according to claim 1, wherein the information memory device is a hard disk device.

6. The control circuit according to claim 2, wherein the information memory device is a hard disk device.

7. A recording method for recording data in a disk recording medium in an information memory device which comprises:
the disk recording medium which rotates and has tracks in which a plurality of data sectors are circularly arranged and data is recorded in each of the plurality of data sectors; and
a head which relatively moves along the tracks of the disk recording medium and records the data in the disk recording medium and reads the data from the disk recording medium,
the recording method comprising:
detecting whether or not the head is positioned at a track to which data sectors of a recording target belongs; and
recording which receives data corresponding to a plurality of data sectors and records the supplied data in data sectors, if it is detected that the head is positioned at the track by the detecting; interrupts the recording, if it is detected that the head is off the track by the detecting; and resumes the recording from a data sector subsequent to the data sector where the detection section detects again that the head is positioned at the track, and begins recording in the data sector where the recording is interrupted when the head is rotated to the interrupted data sector.

8. The recording method according to claim 7, wherein a plurality of servo sectors are disposed at intervals in the track, and a servo pattern indicating a position of the head with respect to the track is recorded in the servo sectors;
the detecting detects a shift amount of the head from the track by reading the servo pattern from each of the plurality of servo sectors; and
the recording resumes the recording according to a locus of the shift amount of the head if the detecting detects that the head is positioned at the track, after detecting that the head runs off from the track.

9. The recording method according to claim 8, wherein the recording resumes the recording from a data sector subsequent to a next servo sector of the servo sector where the detecting detects that the head is positioned at the track, if the detecting detects that the head is positioned at the track after detecting that the head runs off from the track.

10. The recording method according to claim 8, further comprising determining which determines, if the detection section detects that the head runs off from the track, whether or not data is recorded in a data sector antecedent to the servo sector where the detecting detects that the head runs off from the track, according to a locus of the shift amount of the head.

11. The recording method according to claim 6, wherein the information memory device is a hard disk device.

12. An information memory device comprising:
a disk recording medium which rotates and has tracks in which a plurality of data sectors are circularly arranged and data is recorded in each of the plurality of data sectors;
a head which relatively moves along the tracks of the disk recording medium and records the data in the disk recording medium and reads the data from the disk recording medium;
a detection section which detects whether or not the head is positioned at a track to which a recording target belongs;
a recording section which receives data corresponding to a plurality of data sectors and records the data in the corresponding plural data sectors by using the head; and
a control section which causes the recording section to record the data in the data sectors if the detection section detects that the head is positioned at the track; causes the recording section to interrupt the recording if the detection section detects that the head runs off from the track; and causes the recording section to resume the recording from a data sector subsequent to the data sector where the detection section detects again that the head is positioned at the track and also causes the recording section to begin recording in the data sector where the recording is interrupted when the head is rotated to the interrupted data sector.
